(19) United States
(12) Patent Application Publication
(10) Pub. No.: US 2003/0183490 A1
(43) Pub. Date: Oct. 2, 2003

(54) Longitudinal conveyor

(76) Inventor: Friedrich Eschenweck, Feldkirchen (DE)

Correspondence Address: HARNESS, DICKEY & PIERCE, P.L.C., P.O.BOX 8910, RESTON, VA, 20195, US

(21) Appl. No.: 10/275,544

(22) PCT Filed: Apr. 18, 2001
(86) PCT No.: PCT/DE01/01501

(30) Foreign Application Priority Data
May 9, 2000 (DE) 100224849

(51) Int. Cl. B65G 25/04

(52) U.S. Cl. 198/750.1

(57) ABSTRACT

The invention relates to a longitudinal conveyor for conveying electronic components (5) in bar stock magazines (2) along a conveying line (1) by means of a slide (3), which is inserted into the magazine and which is driven by a linear motor with stationary electromagnets (4) and with a permanent magnet placed on the slide. According to the invention, it is not necessary to transfer the components out of customary extruded magazines and into special conveying magazines.

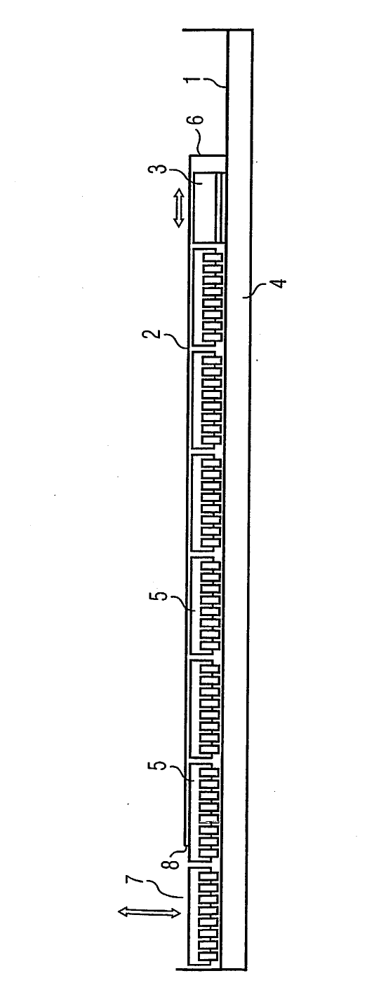

The present invention relates to a longitudinal conveyor, such as is used in particular for the transport of electronic components.

For the automatic inline assembly of circuit boards or ceramic substrates with electronic components, such as resistors, capacitors, diodes, transistors, chips and the like, extruded bar stock magazines are initially filled with the respective components in a magazine filling unit. They are subsequently arranged side-by-side on the vibrating table of a vibrating longitudinal conveyor. The vibrating device of the vibrating table moves the components inside a magazine to the front end of the magazine, which is provided with a flattened and/or countersunk area as removal opening for the components. The individual components readied in the pickup position are then removed when the vibration table stops above a fitting head that picks up the component with a suction pipette, centers it with the aid of levers and deposits it at a predetermined location on the circuit board or the ceramic substrate.

European Patent 0 116 922 discloses a vibrating longitudinal conveyor, intended for transporting electronic components in a magazine specifically designed for this purpose, which is attached to a vibrating table. With a transport of this type, the position and orientation of the components can change in an uncontrolled manner. To ensure a secure removal of the components at the end of the transport line, a pivoting closing part is attached to the end of the magazine. The bent upper portion of this closing part can be used to cover up the removal opening in the magazine during the component transport.

German Patent 31 24 846 C2 discloses a holding device for the magazines, arranged on a vibrating table of a vibrating longitudinal conveyor, which holds the magazines with magnets on the vibrating table. The vibrating table can be covered with a magnetic rubber and provided with positioning pins for this. The magazines are coated at least on the underside with a magnetizable material.

The disadvantage of vibrating longitudinal conveyors of this type is that for the transport and secure removal of the conveyed components special magazines are required, into which the components must be filled. Additionally, the problem occurs that when using only a portion of the existing transport lines, the generated vibrating movement of the vibrating table cannot be adapted sufficiently to the requirements. For example, the removal of a magazine can change the vibrating mass in such a way that the thrust of the remaining magazines is no longer sufficient for conveying the components.

Thus, it is the object of the invention to provide a device for the longitudinal conveying of electronic components with which the components can be transported inside magazines that are for the most part designed independent of the transporting device, such that a secure removal is ensured.

This object is solved with the device having the features as disclosed in claim 1 while the embodiments follow from the dependent claims.

The device according to the invention has a preferably horizontally oriented transport line, provided with a linear motor that drives a slider. The slider is designed such that it can be inserted into commercially available bar stock magazines, used for holding and transporting electronic components. The bar stock magazines with the inserted slider are placed onto the transport line, such that the slider can be operated with the linear motor and can push the components through the magazine to the removal position at the end of the magazine. During the transport, the predetermined orientation of the components is maintained, so as to permit a secure and reliable removal of the components from the magazines at the end of the transport line. The components can be removed with tools that are known per se.

The transport line is preferably designed for transporting several magazines, arranged side-by-side, with their respective sliders. Separate sliders are preferably provided for each magazine. One preferred embodiment provides that the sliders can be operated separately with the linear motor.

The linear motor of one preferred embodiment essentially consists of a sequence of electromagnets, mounted stationary on the transport line and aligned along a straight line. These electromagnets are provided with electric connections to which an alternating voltage can be supplied via a mechanical or electronic commutator, such that the direction of the magnetic pole orientation changes at regular timed intervals. At least one magnet is attached to the slider, which can be a permanent magnet or an electromagnet. All magnets are arranged relative to each other in a manner known per se for linear motors, such that a force is thus generated during the operation of the device for almost any position of the slider between magnets as a result of the generated magnetic field. This force moves the slider forward in longitudinal direction of the transport line. In the process, the slider simultaneously moves the components inside the magazines forward along the transport line.

For one alternative embodiment, the magnetic fields generated by the stationary electromagnets are kept constant and the magnet or magnets on the slider is (are) pole-reversed synchronously with the slider movement. This can be done, for example, automatically with a current collector attached to the slider, which moves across a stationary contact strip, attached over the complete length of the transport line, which is divided into multiple segments.

The device according to the invention in principle can also be embodied with a linear eddy current motor. An eddy current motor of this type is preferably formed with components of the transport line and the slider, for example through electrically conductive walls or the like.

One especially preferred embodiment of the device according to the invention uses a slider provided with a permanent magnet, which can be inserted as separate part into a bar stock magazine and can be used independent of an electrical connection or a mechanical connection to the transport line. The slider is operated with electromagnetic induction. Bar stock magazines can be used for this, in which the components are supplied by the manufacturer and generally are essentially extruded, elongated hollow bodies. Magazines of this type are provided on both ends with openings through which the components are filled in or removed and which are closed off in the meantime with a plug or the like. Following the removal of the plug, the slider can be inserted from one end of the magazine behind the components into the magazine. The magazine is then placed onto the transport line, so that the linear motor can drive the slider. Once the magazine is emptied and the slider has arrived at the opposite end, the slider can be removed and can be inserted into another magazine that is still full.

The enclosed figure illustrates the most important components of the device according to the invention with the aid of an example.

The transport line 1 is provided with a receptacle for a stock bar magazine 2, shown in the example illustrated in the Figure, in which the slider 3 that is intended for transporting the components 5 is inserted from one end 6 through an opening provided therein. The linear motor operates the slider with stationary electromagnets 4, which are attached to the transport line. At the opposite end 8 of the stock bar magazine, the components are pushed out and removed at the removal location 7, which is shown with the drawn-in double arrow.

1. A device for conveying electronic components in longitudinal direction, said device comprising
a transport line (1) with means for accommodating at least one magazine (2) containing components (5) and
means for transporting the components (5) along the transport line (1),
characterized in that
the means for transporting the components
comprise a slider (3) that is provided for conveying the components located inside the magazine along the transport line, as well as
a linear motor with components (4), which are mounted in part stationary along the transport line and in part on or in the slider (3) and which are intended to effect a forward movement of the slider along the transport line.

2. The device according to claim 1,
for which the components of the linear motor are magnets (4) that are installed on the transport line (1) and on or in the slider (3).

3. The device according to claim 1,
for which the linear motor is an eddy current motor, formed by components of the transport line (1) and the slider (3).

4. The device according to one of the claims 1 to 3, for which the transport line (1) is provided with means for accommodating at least two side-by-side arranged magazines (2) and
a separate slider (3) is provided for each magazine (2), which is operated independent of another sliders and is driven by a linear motor.

5. The device according to one of the claims 1 to 4, where the slider (3) is provided such that it can be inserted as separate part into a stock bar magazine (2), independent of an electrical connection or a mechanical connection to the transport line.
